(19) United States
(12) Patent Application Publication
(10) Pub. No.: US 2005/0181346 A1
(43) Pub. Date: Aug. 18, 2005

(54) Creating variants of one or more statements

(76) Inventor: Philip Heller, Mountain View, CA (US)

Correspondence Address: DAVID LEWIS, 1605 THE ALAMEDA, SUITE 204, SAN JOSE, CA, 95126, US

(21) Appl. No.: 11/040,203

(22) Filed: Jan. 21, 2005

Related U.S. Application Data
(60) Provisional application No. 60/545,111, filed on Feb. 17, 2004.

(51) Int. Cl. G09B 3/00; G09B 7/00

(52) U.S. Cl. 434/322; 434/323

(57) ABSTRACT

One or more statements (e.g., exam questions or other statements) are varied using a machine-assisted method. A statement may be entered along with other information, which define rules (e.g., restrictions) for creating variants of the statements. Based on the rules, variants of the statements are generated. In an embodiment, each of the variants have at least some of the structure of the original statement from which the variant was derived.

### CROSS-REFERENCE TO RELATED INVENTIONS

This application claims priority benefit of U.S. Provisional Patent Application No. 60/545,111, filed Feb. 17, 2004, which is incorporated herein by reference.

### FIELD OF THE DISCLOSURE

The current specification defines its own field, which may not have existed heretofore. The current specification relates to an automated process for assisting in writing statements.

### BACKGROUND OF THE DISCLOSURE

The subject matter discussed in the background section should not be assumed to be prior art merely as a result of its mention in the background section. Similarly, a problem mentioned in the background section or associated with the subject matter of the background section should not be assumed to have been previously recognized in the prior art. The subjection matter in the background section merely represents different approaches to accomplishing various tasks.

Variations of statements (e.g., exam questions, letters, and e-mails) are currently written by human beings. For example, certifying Organizations (such as Sun Microsystems, which certifies Java programming skills, Microsoft, which certifies system administration skills, and state motor vehicle departments, which certify knowledge of good driving practices) may use human experts to create pools of exam questions. A single question may require extensive composition, review, editing, and refinement. Unfortunately, unscrupulous examinees may memorize a few questions and then may post the questions on the World Wide Web. Thus, many pools of questions may become compromised.

### BRIEF DESCRIPTION OF THE FIGURES

In the following drawings like reference numbers and labels are used to refer to the same elements. Although the following figures depict various examples of inventions associated with this specification, the inventions associated with this specification are not limited to the examples depicted in the figures.

FIG. 1 shows a block diagram of a system used for creating, distributing, and using variations of statements.

FIG. 2A shows a block diagram of a computer system used in the system FIG. 1.

FIG. 2B shows a block diagram of an example of memory system used in the computer system of FIG. 2A.

FIG. 3 shows a block diagram of flowchart of an example of a machine-aided method for generating variations of statements, such as exam questions.

FIG. 4A shows a block diagram of an example of a method for implementing the second step of FIG. 3.

FIG. 4B shows a block diagram of another example of a method for implementing the second step of FIG. 3.

FIG. 5 shows a block diagram of an example of a method for implementing the third step of FIG. 3.

FIG. 6 shows a block diagram of an example of a method for implementing the fourth step of FIG. 3.

FIG. 7 shows a block diagram of an example of a method for implementing the fifth step of FIG. 3.

FIG. 8 shows a block diagram of an example of a method for implementing sixth step of FIG. 3.

FIG. 9 shows a block diagram of an example of a method for implementing the seventh step of FIG. 3.

### DETAILED DESCRIPTION OF SOME EXAMPLES OF SOME EMBODIMENTS OF THE INVENTION

Although the issues discussed in the background or elsewhere may have motivated some of the subject matter disclosed below, nonetheless, the embodiments disclosed below do not necessarily solve all of the problems associated with the subject matter discussed in the background or elsewhere. Some embodiments only address one of the problems, and some embodiment do not solve any of the problems associated with the subject matter discussed in the background or elsewhere.

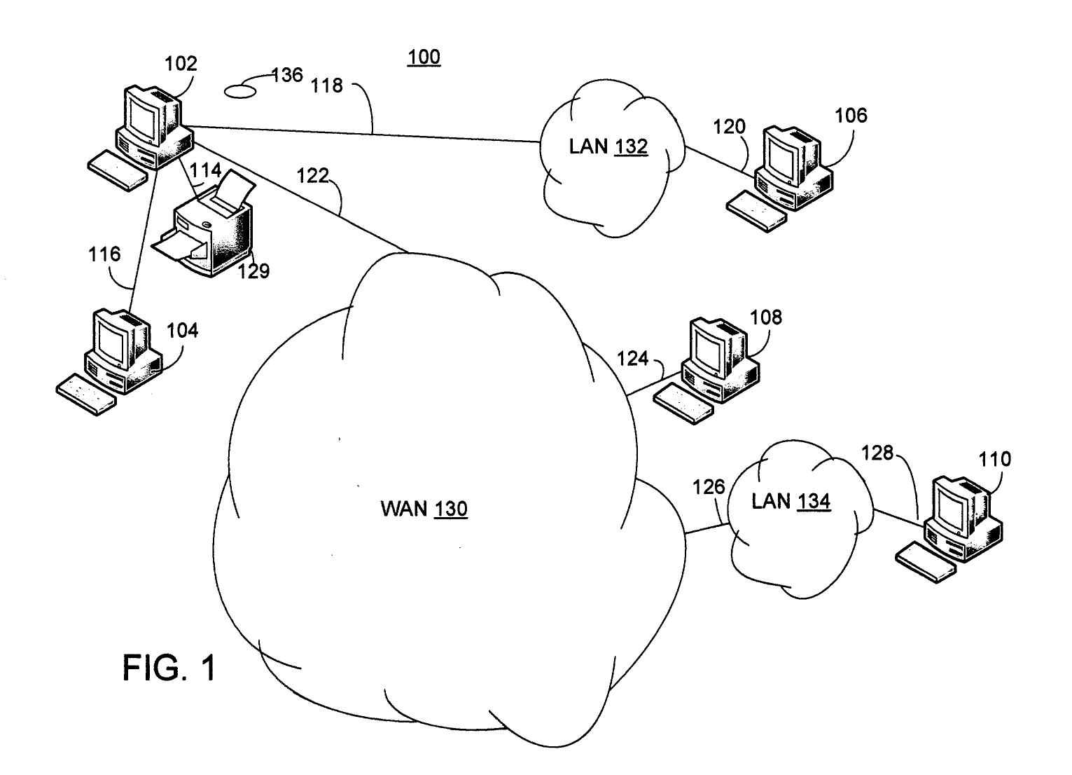

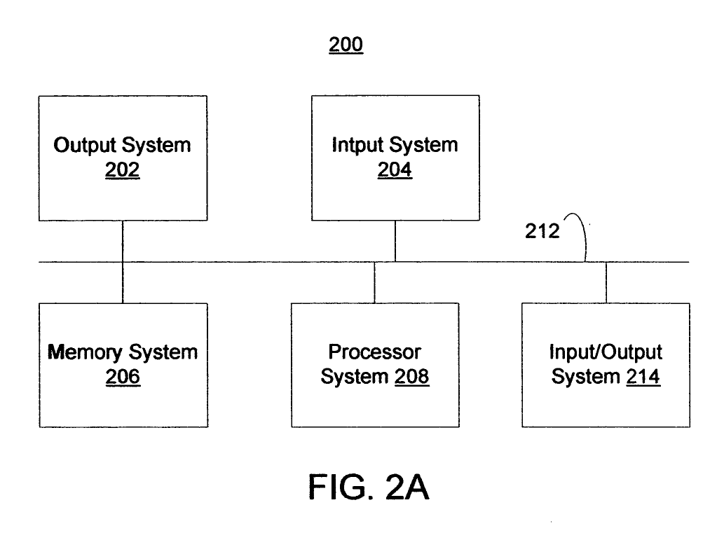

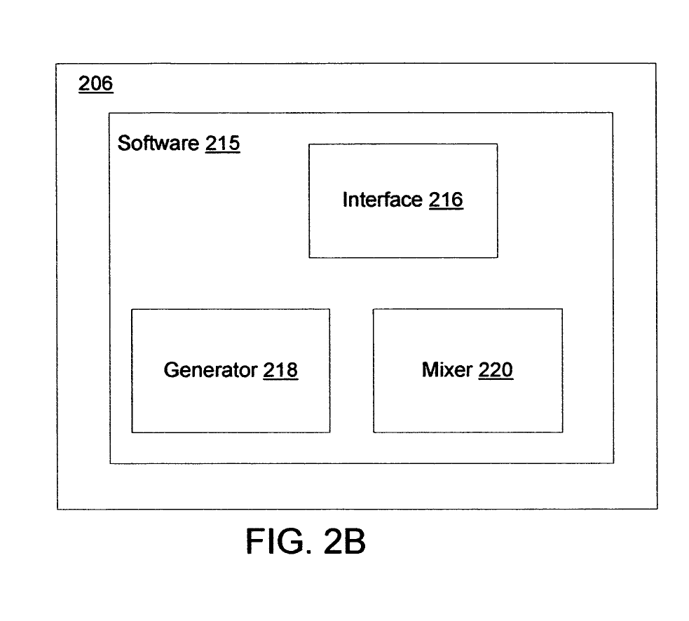

In general, at the beginning of the discussion of each of FIGS. 1-2B is a brief description of each element, which may have no more than the name of each of the elements in the one of FIGS. 1-2B that is being discussed. After the brief description of each element, each element is further discussed in numerical order. In general, each of FIGS. 1-9 is discussed in numerical order and the elements within FIGS. 1-9 are also usually discussed in numerical order to facilitate easily locating the discussion of a particular element. Nonetheless, there is no one location where all of the information of any element of FIGS. 1-9 is necessarily located. Unique information about any particular element or any other aspect of any of FIGS. 1-9 may be found in, or implied by, any part of the specification.

A “variant” of an exam question is a modification of the question that maintains the original question's structure, but changes some of its elements. For example, an exam question may be

If a pond contains 3 ducks, 4 geese, and 5 fish, how many birds does it contain?
A) 7
B) 8
C) 9
D) 12
   A variant of that question is

If a forest contains 30 gorillas, 40 orangutans, and 50 zebras, how many primates does it contain?
A) 70
B) 80
C) 90
D) 120
   The variant maintains the underlying structure of the original while varying the numbers and the types of animals.

An embodiment of the invention includes a computer program into which a user enters an original question or other statement (which will be referred to as the “starter”), along with information about the structure and elements of the starter. The program then generates large numbers of variants on the starter. In one embodiment, the starter is one of any combination of, or a combination of all of a test question, the answer set to the test question, the explanation of the answer, and/or other text related to the question.

An embodiment of the invention includes a software-assisted method for creating exam question variants. In an embodiment of the invention creates a starter question or other statement, which may still take extensive time, effort, and expertise. However, once a starter question and its structural information have been entered into software 215, thousands and even millions of variants can be created automatically in a matter of seconds. Currently, for a sufficiently compromised exam, an examinee who has thoroughly studied illicitly posted questions and is now taking the exam, stands a very high chance of being asked a question that he or she has read on the web. An embodiment of the invention may significantly reduce the odds of an examinee being asked a question that someone else has posted. In some cases the chances that examinee will be asked a question that someone else posted may be reduced to nearly zero.

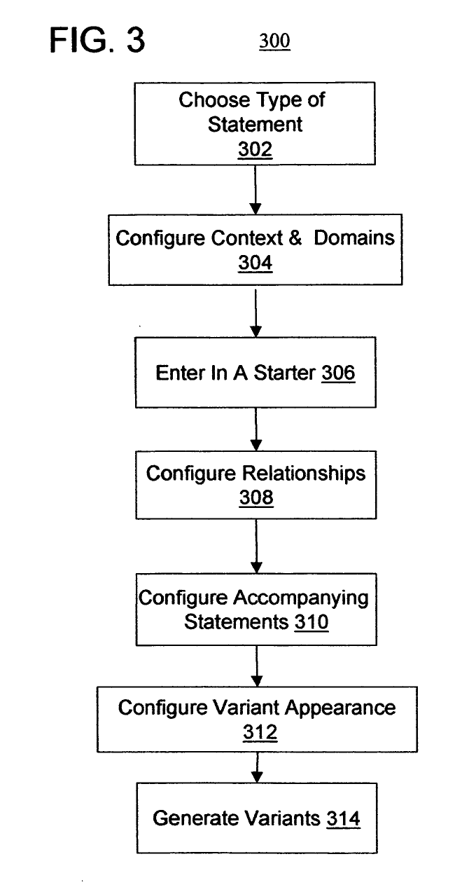

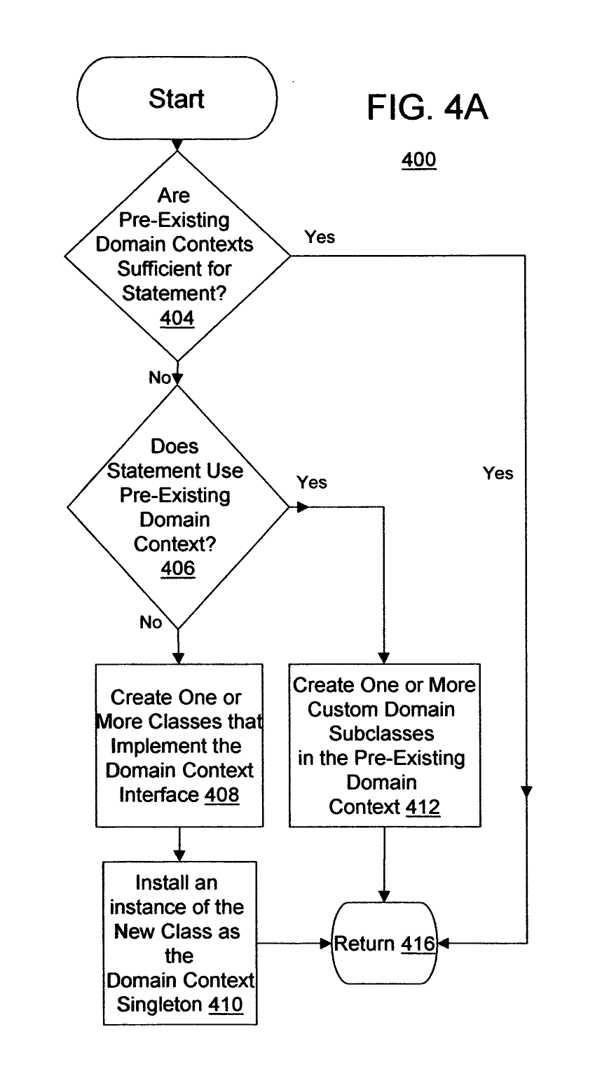

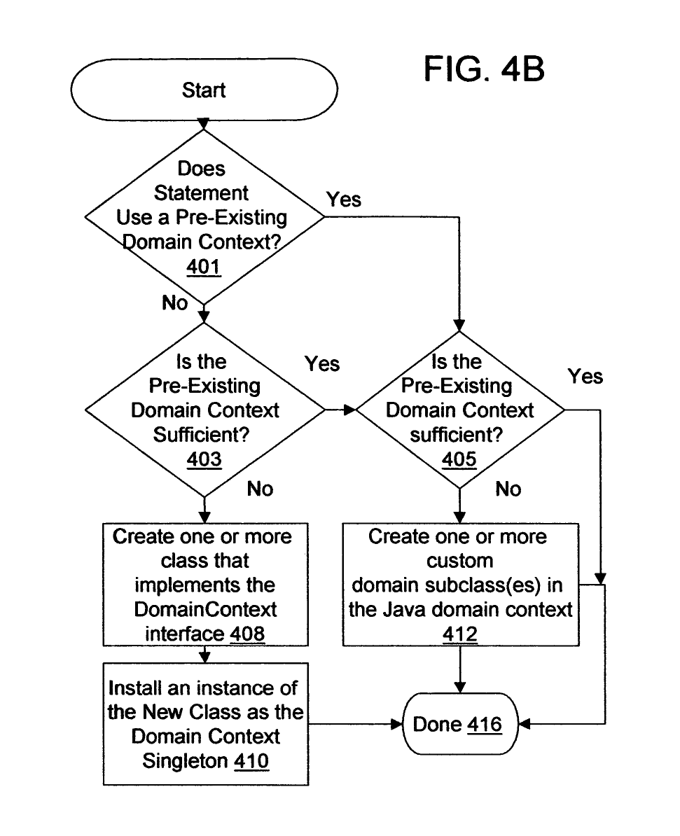

FIGS. 1, 2A, and 2B show a system for implementing an embodiment of the invention. The overall steps involved in using one embodiment of the invention are shown in FIG. 3, and further details are given in FIGS. 4-9.

FIG. 1 shows a block diagram of a system 100 used for creating, distributing, and using variations of statements. System 100 may include computer systems 102, 104, 106, 108, 110, and 112, links 114, 116, 118, 120, 122, 124, 126, and 128, printer 129, Wide Area Network (WAN) 130, and Local Area Networks (LANs) 132 and 134, machine-readable medium 136. In other embodiments, system 100 may include additional components and/or may not include all of the components listed above.

System 100 illustrates examples of a variety of ways in which a computer system (computer system 100) may be linked for sharing variants of a set of statements. Computer system 102 creates and distributes variants of statements, such as questions. As one example in which variants may be distributed, the variants may be sent from system 102, via link 114, to printer 129, and a hard copy may be printed. In the case where the variants are questions, the hard copies could be a set of exams in which questions are answered using writing utensils, such as pencils and/or pens. As another example, the variants may be sent, via link 116 for use at computer system 104. Similarly, variants may be sent via link 118 to LAN 132 to link 120 for use at computer system 106. Additionally, variants may be sent via link 122 to WAN 130 to link 124 for use at computer system 108. Further, variants may be sent via link 122 to WAN 130 to link 126 to LAN 134 to link 128 for use at computer system 110. The variants may also be placed on a machine-readable medium 136, such as a Compact Disc (CD), floppy disc, zip disc, or flash memory and then transferred via the machine-readable memory to computer systems 102, 104, 106, 108, 110, and/or 112.

At computer systems 102, 104, 106, 108, 110, and/or 112 the variants may be used on line, at the computer, and/or printed. For example, if the variants are exam questions, the exams using the variants may be taken on line, at the local computer, and/or printed and taken using a writing utensil. Alternatively, computer system 102 may be used for composing the original statements, and the variants may be generated at computer systems 104, 106, 108, 110, and/or 112. Alternatively, computer system 102 may send the original statements and the rules (e.g., restrictions, other ways of defining the structure, and/or other rules), such as word associations used for creating variants, to the other computer systems. Alternatively, the original questions, rules, word associations, and/or the variants may be generated at anyone of or any combination of computers 102, 104, 106, 108, 110, and/or 112 and sent to the others of computer systems 102, 104, 106, 108, 110, and/or 112.

Each of computer systems 102, 104, 106, 108, 110, and/or 112 may be a single device or a group of several devices, which may be all of the same type or of several different types. For example, each of computer systems 102, 104, 106, 108, 110, and/or 112 may be any combination of one or more personal computers, laptops, handheld computing devices, web appliances, terminals, work stations, and/or mainframe computers.

Any of links 114, 116, 118, 120, 122, 124, 126, and 128 may be any combination of electrical wire, optical fiber, radio wave, other wireless communications, or other types of communications links. Although only five computer systems are depicted, system 100 may include any number of computer systems, which may be linked to one or more other computer systems that are linked to one or more other computers for generating and/or distributing variants or statements. The manners in which the computer systems are linked are not limited to just the few combinations of links, WANs, and LANs illustrated, but any combination of, having any number of, links, LANs, WANs and/or other communication networks and/or systems may be used.

FIG. 2A shows a block diagram of a computer system 200 used in system 100. The computer system 200 may include output system 202, input system 204, memory system 206, processor system 208, communications system 212, and input/output device 214. In other embodiments, computer system 200 may include additional components and/or may not include all of the components listed above. Computer system 200 may be used for any one of; any combination of, or all of computer systems 102, 104, 106, 108, 110, and 112.

Output system 202 may include any one of, some of, any combination of, or all of a monitor system, a handheld display system, a printer system, a speaker system, a connection and/or interface system to one or more sound systems, a connection and/or interface system to one or more peripheral devices, a connection and/or interface system to one or more computer systems, a connection and/or interface system to one or more LANs, and/or a connection and/or interface system to one or more WANs, for example.

Input system 204 may include any one of, some of, any combination of, or all of a keyboard system, a mouse system, a track ball system, a track pad system, buttons on a handheld system, a scanner system, a microphone system, a connection and/or interface to a sound system, and/or a connection and/or interface system to a computer system, a connection and/or interface to an intranet, and/or a connection and/or interface to an internet (e.g., IrDA, USB), for example.

Memory system 206 may include, for example, any one of, some of, any combination of, or all of a long term storage system, such as a hard drive; a short term storage system, such as random access memory and/or flash memory; and/or a removable storage system, such as a floppy drive or a removable drive. Memory system 206 may include one or more machine-readable mediums that may store a variety of different types of information. The term machine-readable medium is used to refer to any medium capable carrying information that is readable by a machine. One example of a machine-readable medium is a computer-readable medium. Another example of a machine-readable medium is paper having holes that are detected that trigger different mechanical, electrical, and/or logic responses. The term machine-readable medium also includes mediums that carry information while the information is in transit from one location to another, such as copper wire, optical fiber, air, and/or any other medium for carrying electrical energy, electromagnetic energy, and/or other forms of signals.

Processor system 208 may include any one of some of, any combination of, or all of multiple parallel processors, a single processor, a system of processors having one or more central processors and/or one or more specialized processors dedicated to specific tasks. Also, processor system 208 may include one or more Digital Signal Processors (DSPs) in addition to or in place of one or more Central Processing Units (CPUs) and/or may have one or more digital signal processing programs that run on one or more CPUs.

Communications system 212 communicatively links output system 202, input system 204, memory system 206, processor system 208, and/or input/output system 214 to each other. Communications system 212 may include any one of, some of, any combination of, or all of electrical cables, fiber optic cables, and/or means of sending signals through air or water (e.g., wireless communications), or the like. Some examples of means of sending signals through air and/or water include systems for transmitting electromagnetic waves such as infrared and/or radio waves and/or systems for sending sound waves.

Input/output system 214 may include devices that have the dual function as input and output devices. For example, input/output system 214 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 214 is optional, and may be used in addition to or in place of output system 202 and/or input device 204.

FIG. 2B shows a block diagram of an example of memory system 206. Memory system 206 includes software 215, which includes interface 216, and generator 218 and mixer 220. In other embodiments, memory system 206 may include additional components and/or may not include all of the components listed above.

Software 215 creates the variants of a set of one or more statements. The original set of statements, word associations, and rules are entered into software 215, via interface 216. Interface 216 may include a graphical user interface, a module for receiving data that is scanned in to computer system 200, and/or another means of receiving data.

Generator 218 controls mixer 220 and, together, mixer 220 and generator 218 generate variants of a statement based on input received via interface 216. Interface 216, generator 218, and mixer 220 are discussed further in conjunction with FIGS. 3-9. Interface 216, generator 218, and mixer 220 may be software objects, methods, subroutines, groups of one or more lines of code. Lines of code associated with interface 216, generator 218, and/or mixer 220 may be lines of code that are not located next to one another, but are dispersed among other lines of code within software 215.

In an embodiment of the invention in which the statements are questions, after the question and the answer set of a multiple choice or multiple true/false exam has been varied, the order of the answer for a given question may be changed in a random manner. Similarly, the order of the questions may be changed in a random manner to ensure that an unscrupulous examinee cannot pass the exam by merely memorizing a sequence of choices (e.g., A, B, D, A) despite the variation of the wording of the questions.

FIG. 3 shows a block diagram of a flowchart of an example of a machine-aided method 300 for generating variations of statements, such as exam questions. In method 300, in one or more places a “user input” is specified. It should be understood that a user input may involve presenting to a user a prompt or a field for entering the input using output 202 and/or input/output 214 as indicated by interface 216. The user then enters information via input 204 and/or input/output 214. In response to the user entering the input, system 100 receives one or more signals indicating the performance of one or more steps, based upon the input. In an embodiment, the information received is then handled by interface 216 of software 215 prior to being further processed by generator 218 and mixer 220.

In step 302, the type of question or other statement is chosen. In an embodiment, step 302 is performed with the aid of output 202, input 204, and/or input/output 214 in conjunction with interface 216 as described in the previous paragraph. Any number of different types of questions or other statements may be supported by any given embodiment of the invention. One embodiment of the invention supports two kinds of exam questions, which are Multiple Choice and Multiple True/False. In a Multiple Choice question, only one of the possible answers is correct. For example:

Which one of the following people worked in a patent office?
A) Albert Einstein
B) Salvador Dali
C) Elvis Presley

In a Multiple True/False question, more than one of the possible answers may be correct. For example:

Which of the following people worked in a patent office? (choose all the correct answers)
A) Albert Einstein
B) Salvador Dali
C) Elvis Presley
D) Thomas Jefferson

In an embodiment, the user begins by specifying the type of statement, such as whether the statement to be processed is Multiple Choice, Multiple True/False, or other statement. The user's entry is received by system 100. Alternatively, system 100 may automatically detect the type of statement after the statement has been entered. In other embodiments, other types of questions or any of a number of other types of statements may be supported by system 100.

In step 304, the context of the statement is configured. In an embodiment, step 304 is performed with the aid of output 202, input 204, and/or input output 214 in conjunction with interface 216.

The context of a statement, such as a question, is the field of expertise to which the statement pertains. In the first example above (ducks and geese), the context may be ecology, wildlife, or hunting, for example. Other examples of contexts may include, but are not limited to, Java programming, Microsoft system administration, and driving a car.

A domain is a set of related words that have specific meaning within the context of the statement. For example, in the ecology context, one domain may be “animals,” which may contain, but is not limited to, “ducks,” “geese,” “fish,” “gorillas,” “orangutans,” “zebras,” “birds,” and “primates.” Another domain may be “habitats,” which may contain, but is not limited to, “pond” and “forest.” Another domain that appeared in the example question above, which is likely to be useful in many contexts, is the domain of numbers.

In the above example, the animals domain may be hierarchical. Specifically, ducks and geese are specific kinds of birds, and gorillas and orangutans are specific kinds of primates. Optionally, the system may keep track of the hierarchy within different domains. Thus, in an embodiment, the information that software 215 stores about domains includes not only the names of the members of the domains, but also any hierarchical relationships among the members of the domain. Alternatively, the system may not keep track of the hierarchy within domains.

When software 215 causes system 100 (via generator 218 and mixer 220) to generate variants, system 100 finds words in the starter statement that belong to domains and replaces every instance of such words with other words from the same domain. In an embodiment in which the hierarchy of the domains is stored, the hierarchical relationships among its members may be maintained while performing the replacements. In the example of the two questions above, “duck” was replaced by “gorilla,” and “bird” was replaced by “primate.” The hierarchical relationships of the animals domain were first established in the starter statement, which in this example is a starter question. Then, while varying the starter, the hierarchical relationships were maintained among the words belonging to the “animals” domain.

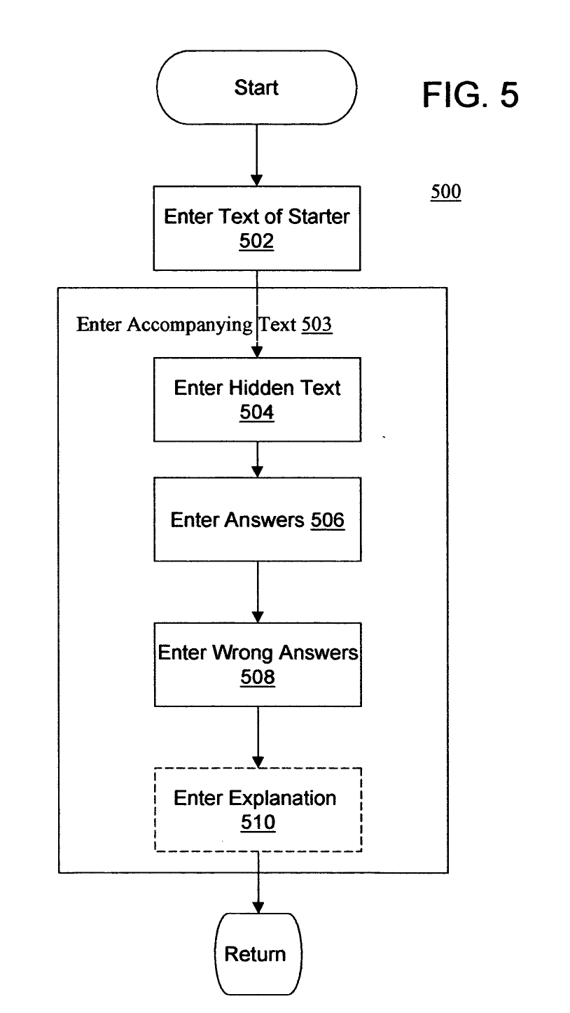

In the Java Programming context, domains may include numbers, primitive data types, access modifiers, and operators, for example. In an embodiment, software 215 comes with one or more built-in contexts, such as a Java Programming context. For questions from other contexts, additional domains and contexts may need to be created. For example, contexts may be created by implementing a Java interface, which may be called sphinx.DomainContext. Domains may be created by extending an abstract Java class, which may be called sphinx.Domain. Step 304 is discussed further in conjunction with FIG. 5, which is discussed below.

In step 306 a starter is entered. In an embodiment, step 306 is performed by input 204, output 206, and/or input/output 214 with the aid of interface 216. Output 206 and/or input/output 214 present a field or a prompt to the user as indicated by interface 216. Then, in response, the user inputs the starter using input 204 and/or input/output 214, and the information received is handled according to interface 216.

In an embodiment, software 215 causes output 202 and/or input/output 214 to provide text areas, via interface 216, for the user to enter the starter text and/or answers. In an alternative embodiment, input 204 and/or input/output 214 scans an exam and, using a character recognition program, software 215 causes system 100 to extract a starter text and/or answers, which are received according to interface 216. In an embodiment in which software 215 causes system 100 to automatically detect the type of statement, step 302 may be performed after step 306.

As each word is entered, software 215 checks to see if the word belongs to a domain. Optionally, all words that belong to domains are color highlighted, using a different color for each domain. In an embodiment that keeps track of domain hierarchy, if a word belongs to a domain containing hierarchically related members, software 215 recognizes that word's relationships to other words in the starter that belong to the same domain. In an embodiment, the hierarchical relationships are maintained in all variants that software 215 generates.

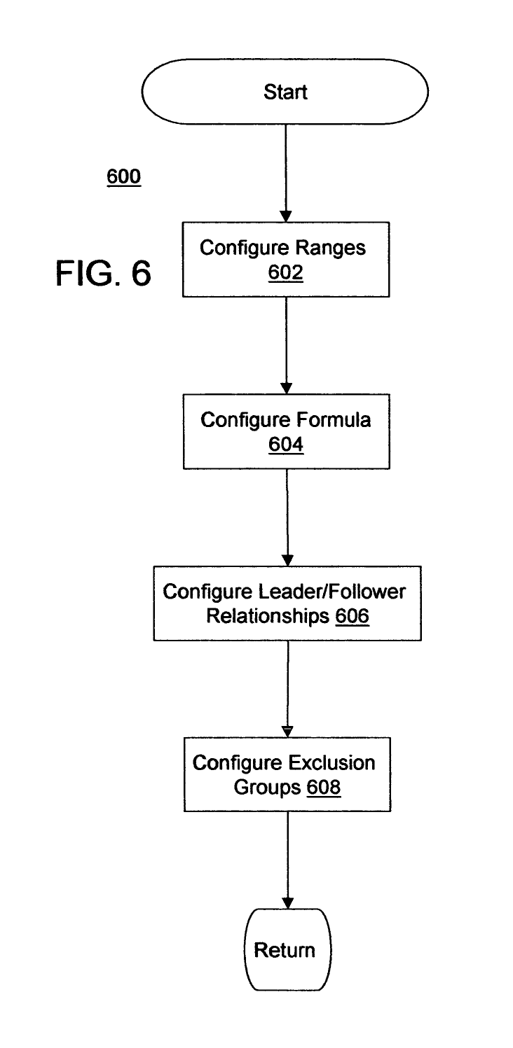

Optionally, in addition to varying the starter statement, there may be a variety of other types of accompanying text that are varied in a manner that is consistent with the variation of the starter statement. For example, when the statement is a question, in addition to varying the question and answer, other text such as an explanation of the answer may be varied in a manner consistent with the variation of the question and answer. For example, the user may enter optional “hidden text” and an optional “explanation.” An “explanation” refers to an explanation to an answer of the question. Both hidden text and explanations do not appear to the examinee while the examinee is taking the exam. However, hidden text refers to texts that, in addition to not appearing on the exam, are also not explanations. Hidden text may or may not appear along side of an explanation of an answer. As an example, hidden text may include instructions about how to grade the question, which is never shown to the examinee. In an exam in which the questions are read out loud to the examinees, the hidden text may be reading instructions. The hidden text and explanations can participate in relationships, which are explained below. Explanations are often useful in practice exams that often appear on web sites or in study guide books. Explanations and hidden text may be automatically modified in agreement with the variation of the starter. Step 306 is discussed further in conjunction with FIG. 6, which is discussed below.

In step 308, word properties are configured. In an embodiment, similar to steps 302,304, and 306, step 308 is performed by via output 202, input 204, and/or input/output 214 in conjunction with interface 216.

In an embodiment, software 215 allows the user to specify certain properties of words that belong to domains. There may be any number of properties that the user can specify. Some examples of properties are:
Ranges
Formulae
Leader-follower Relationships
Exclusion Groups

The “range” of a word in the starter is the set of words that may replace the starter word in a variant. By default, the range of a word that belongs to a domain is the entire set of words of the domain. The user may limit the range of a word to just a portion of the domain.

A “formula” is a simple mathematical or logical expression that indicates to software 215 how to cause system 100 to derive a word in a variant, based on other words in the variant. Usually, all words involved in a formula are numbers. In our first example, answer (A) was 7; it was the correct answer because it was the sum of the number of ducks (3) and the number of geese (4). Variants are produced by substituting other reasonable values for “3” and “4,” but the correct answer must always be the sum of those values. Software 215 allows the user to specify a formula that dictates that the word in answer “A” is the result of adding the number of ducks plus the number of geese. Not all words involved in the formulae are numbers. For example, in the Java programming context, as well as other programming contexts, formulae can be applied to non-numeric words in order to generate substrings.

A “leader-follower” relationship can be applied to any pair of words, even if the pair of words comes from different domains. A leader-follower relationship states that whenever one of the words (the “leader”) has a certain value, then the other word (the “follower”) must have a certain other value. In our example, if the 6th word is “ducks,” then the 3rd word should be “pond” (and never “forest” or any other word of the Habitat domain). Similarly, in any variant where the 6th word is “gorillas”, the 3rd word should be “forest”. One manner of enforcing this restriction is by creating a leader-follower relationship in which the 6th word is the leader of the 3rd word. In an embodiment, when the user sets up this relationship, software 215 causes a prompt to be presented on output 202 and/or input/output 214 for a list of leader values and the associated follower values.

In an embodiment, the leader follower relationships may be unrelated to which number word in a sentence a particular word appears. For example leader follower relationships may relate a series of words across several domains. Thus, from a set of domains of animals, habitat, and locomotion a leader follower relationship may exist for duck from the domain animals, paddle and waddle from the domain locomotion, and pond and nest from the domain habitat. This leader follower relationship may have a sub-leader follower relationship between paddle and pond. Thus, whenever duck is chosen from domain animal as a substitute for a different animal, the words that may be chosen from domain locomotion as a substitute for another word from domain locomotion must be either paddle or waddle. Similarly, if the word duck is chosen, the word that must be used from domain habitat must be nest or pond. If paddle is now chosen from domain locomotion, the sub-leader follower relationship additionally requires that the word that must be used from domain habitat is pond.

An “exclusion group” is a group of words that are all from the same domain and that must not have the same value in any variant. In the above example question, it would be useless to produce a variant that began, “If a forest contains 20 gorillas, 30 gorillas, and 5 gorillas . . . .” All three animals must be distinct. Software 215 allows the user to specify all groups of words that must always be distinct in all variants.

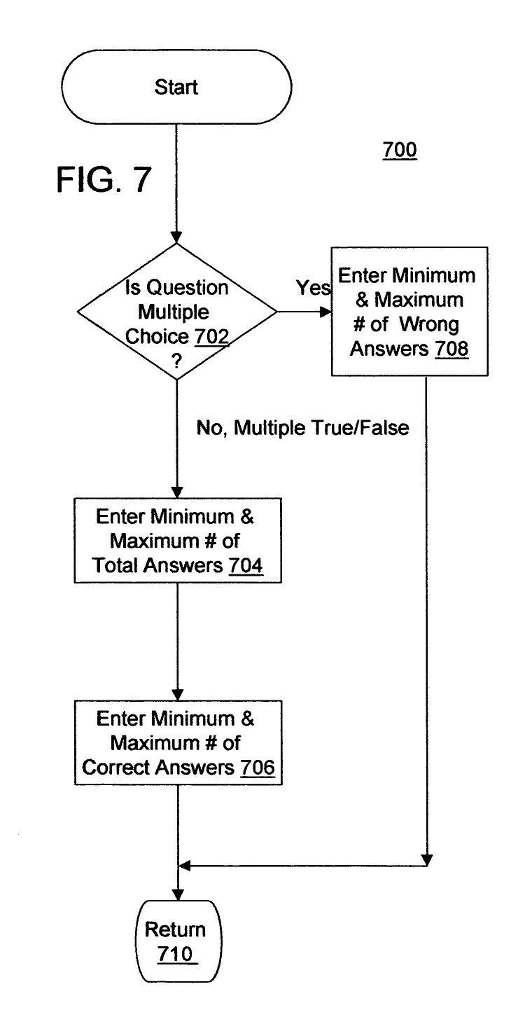

In one embodiment, the above properties are all of the properties that are specified. In other embodiments, only one of or any combination of the above properties can be specified. In other embodiments, other properties may be specified instead of or in addition to any one of, any combination of, or all of the above properties. For example, certain parts of a question or other statement may be required to satisfy certain syntactical relationships, such as that of a statement or clause of a computer program. Step 308 is discussed further in conjunction with FIG. 7, which is discussed below.

In step 310, the accompanying statements are configured. In an embodiment, similar to the prior listed steps of method 300, step 310 is performed via output 202, input 204, and/or input/output 214 in conjunction with interface 216. In step 310, if there are any restrictions that must be satisfied by the accompanying statements, a check is made to ensure that these restrictions are satisfied. If the restrictions are not satisfied, the accompanying statement is either modified to meet the restrictions or the entire variation is thrown out.

For example, in the case of an exam question, it is possible that in some variants, some answers within an answer set will be the same as other answers of the same answer set, which would be undesirable. For example, the following variant is undesirable:

If a pond contains 3 ducks, 4 geese, and 5 fish, how many birds does it contain?
A) 7
B) 8
C) 8
D) 8

In an embodiment, software 215 causes system 100 to discard any duplicate answers. Thus for example it is possible for a starter to have 6 wrong answers, while a variant of that starter only has 2 wrong answers (if 4 were discarded as duplicates). In step 310, the user specifies the minimum acceptable number of wrong answers. Any variant that does not meet this criterion may be corrected or discarded. For multiple true/false questions, duplicate correct answers are possible, and are likewise discarded. In an embodiment, the user can also specify the minimum acceptable number of correct answers for multiple true/false questions. For a multiple true/false question, the user can also specify a formula for determining the truth value (“true,” or “false”) of any of the answers. An example of step 310, which relates to exam questions, is discussed further in conjunction with FIG. 7.

In step 312, the appearance of a variant is configured. In an embodiment, similar to the prior listed steps of method 300, step 312 is performed via output 202, input 204, and/or input/output 214 in conjunction with interface 216.

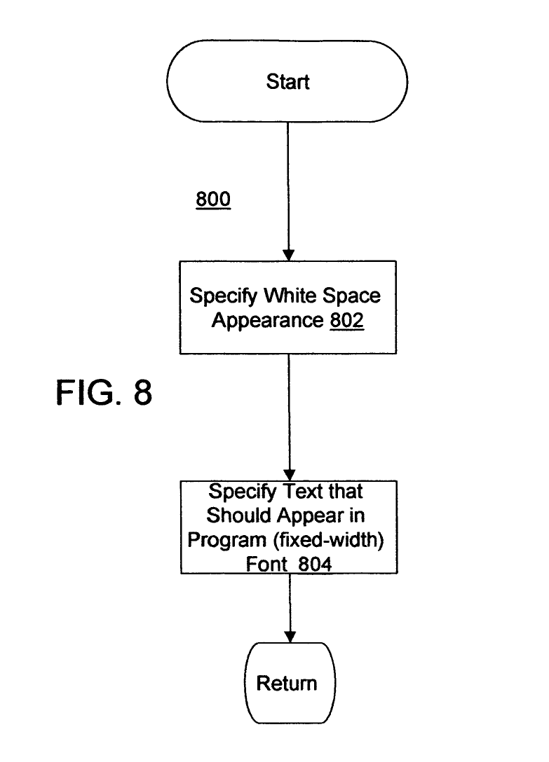

In step 312, the user specifies the appearance of a variant when the variant is presented to an examinee. The user may be able to specify a variety of different parameters that relate to the format and other factors related to the appearance of the variant. For example, the user may be able to specify how to present white spaces and which fonts to use. (“White space” is text that cannot be seen, including spaces, tabs, and new line characters.) The user may also specify any runs of text that should be presented in fixed-width font. For example, it may be desirable to have software source code appear in fixed-width font, and have all other text appear in regular font. Step 312 is discussed further in conjunction with FIG. 8, which is discussed below.

In step 314, the variants are generated. In an embodiment, a combination of generator 218 and mixer 220 causes processor 208 to perform step 314.

At step 314, system 100 has all the information it needs to generate variants when implementing the instructions associated with software 215. However, the number of variants may be astonishingly high. Sometimes the number of variants may be in the hundreds of millions. On the other hand, a starter that one believed would produce many variants might in fact produce only a few variants. Consequently, in an embodiment, prior to actually generating the variants, the total number of possible variants is determined. In an embodiment, software 215 automatically calculates the number of possible variants. In another embodiment, software 215 only causes the number of possible variants to be calculated when a request is received for a calculation of the number of variants. If the number of variants is relatively small, the user may desire to make the starter less restrictive (for example by assigning wider ranges or different formulae). In an embodiment, the decision as to how to make the starter less restrictive may be performed automatically. If the number of variants is acceptable and reasonably small computer system 100 may be caused by software 215 to generate all possible variants. If the number of variants is so large that storing all of them would consume too much hard disk space, the program can cause system 100 to be directed to generate a specified number of randomly chosen variants.

Software 215 causes a variant to be generated by identifying words that may vary independently of any other words, such as words that are not followers and are not the result of formulae. Each such word in each domain is attached to a software object, which may be called a “varier.” In an embodiment, there is one varier for each domain. The varier is capable of generating sets of values for each word it controls. In an embodiment, not all possible values are generated. The values produced by a generator respect the following restrictions:
The hierarchical relationships of the original starter
Any ranges that the user may have specified for any words
Any exclusion groups that the user may have created

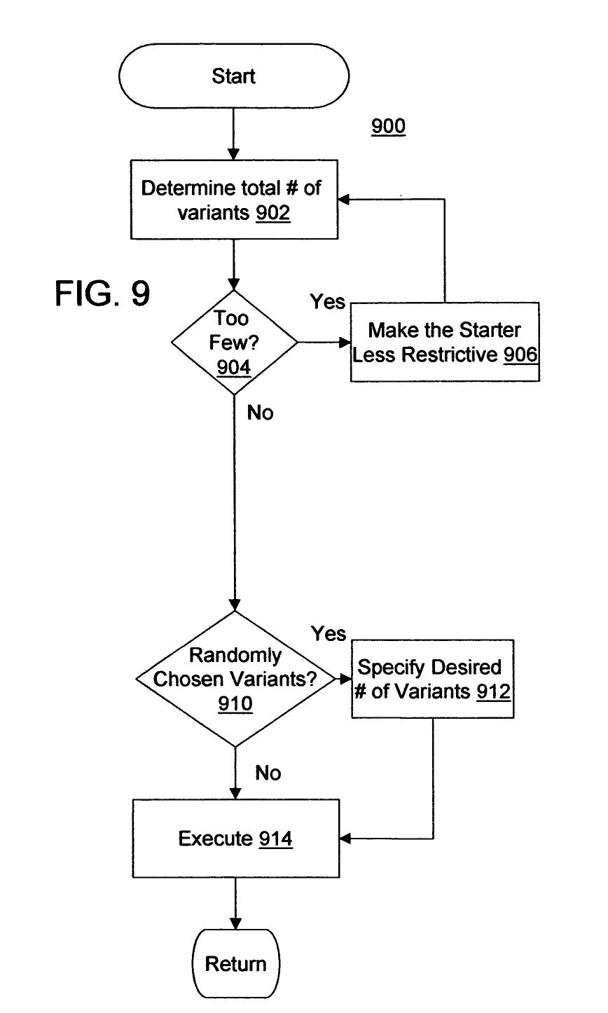

Step 314 is discussed further in conjunction with FIG. 9, which is discussed below.

Mixer 220 can cause system 100 to be directed to generate all possible combinations derivable from a starter, a specified number of randomly selected unique combinations, or a single randomly selected combination (the collection of all possible combinations may be referred to as a “sequence”).

Mixer 220 and its variers may not generate all of the words that constitute a variant. As mentioned above, the mixer and its variers may only generate words that are not followers and are not the result of formulae. After mixer 220 and its variers have been used for generating the desired number of possible combinations, the remaining words can be generated.

fgMMixer 220 is controlled by a software object, which may be called generator 218. Generator 218 directs mixer 220 to cause system 100 to create one or more sets of words. In an embodiment, generator 218 has access to all leader-follower and formula information, and is able to derive values for all the words that were not generated by mixer 220 and the variers of interest. The result may be a complete variant that maintains all the hierarchical relationships of the original starter, and honors all the restrictions that the user has specified (e.g., ranges, formulae, leader-follower relationships, and/or exclusion groups).

Except for the possibility that the number of answers may not be an acceptable number, prior to step 314 the question is ready to be presented in an exam. Consequently, a check of the text accompanying the statement (e.g., answers to question) is then performed. In an embodiment, mixer 220 causes the performance of the check. Referring to the example of an exam question, mixer 220 may cause duplicate correct and incorrect answers to be discarded. If discarding answers causes the total number of correct or incorrect answers to fall below the limit specified by the user, mixer 220 may discard the question. Alternatively, if the number of answers falls below the specified limit, generator 218 or mixer 220 may cause new answers to be generated. For example, if the number of answers falls below the specified limit, because duplicate false answers were discarded, new false answers may be generated. If the false answers thrown away were numerical (e.g., an incorrect number representing the number of primates), new false numbers may be generated. For example, consider a situation in which the required number of answers is 4, and question and answers generated are If a pond contains 3 ducks, 4 geese, and 5 fish, how many birds does it contain?
A) 7
B) 8
C) 8
D) 8

Then the “C” answer may be changed to another integer randomly selected from a range of integers, such as 10, and “D” answer may be changed to another integer randomly selected the range of integers, such as 11. The range of integers may be chosen to be a range of integers that are close to or likely to be confused with the correct answer. Consequently, the varied question becomes

If a pond contains 3 ducks, 4 geese, and 5 fish, how many birds does it contain?
A) 7
B) 8
C) 10
D) 11

In an embodiment of the invention, in step 314, after the question and answer of a multiple choice or multiple true/false exam has been varied the order of the answer for a given question may be changed in a random manner. Similarly, at the end of step 314, the order of the questions may be changed in a random manner to ensure that an unscrupulous examinee cannot pass the exam by merely memorizing a sequence of choices (e.g., A, B, D, A) despite the variation of the wording of the questions.

This description has assumed an environment in which variants can be generated, stored, and distributed (electronically via the Internet, or physically by shipping a storage medium such as a CD-ROM) to testing locales. In lieu of distributing a large number of variants, it is also possible to distribute starters, along with related context and configuration information. Distributing the starters and the related contexts would greatly reduce the volume of information to be transmitted, possibly by a factor of millions. In this embodiment, the sites to which the starter and related context are sent (e.g., computer systems 102, 104, 106, 108, 110, and 112) would have copies of generator 218 and mixer 220 and/or other variant-generating software.

In other embodiments, method 300 may include additional steps, may have one or more of the above steps in a different order, and/or may not include all of the steps listed above.

FIG. 4A shows a block diagram of an example of a method 400 for implementing step 304 of FIG. 3. In step 404, a decision is made whether any pre-existing contexts will be adequate from the statement of interest. For example, if a Java context exists and the statement being varied is an exam question, a decision is made whether the Java context is adequate for varying the question. This decision may be made automatically or via the user. If the pre-existing contexts (e.g., a Java context) are not adequate, then in step 406 a determination is made whether any of the pre-existing contexts are nonetheless useful. If the pre-existing contexts would not be useful, the method proceeds to step 408. In step 408, a new program entity that uses the system's interface may be generated for the new context. The new program entity may be one or more objects, classes, subroutines, lines of code, and/or values for program variables. Next, in step 410, if necessary, the new program entity is installed. For example, if the new program entity is a class, an instance of the new class is installed. If the new program entity is a value for a variable, the value of the variable is set or changed, and step 410 is unnecessary.

Returning to step 406, if the pre-existing context is useful, the method proceeds to step 412. In step 412, the pre-existing context is added to and/or modified, thereby creating a new context. For example, a new domain may be added to the pre-existing context and/or words may be added or removed from a pre-existing domain of the pre-existing context.

Returning to step 404, if the Java context is adequate, method 400 is finished at return 416, which returns control to the next step in FIG. 3. Similarly, after completing step 404, 410, or 412 control returns to the next step of FIG. 3, as indicated by return 416.

In other embodiments, method 400 may include additional steps, may have one or more of the above steps in a different order, and/or may not include all of the steps listed above.

FIG. 4B shows a block diagram of another example of a method 450 for implementing step 304 of FIG. 3. Method 400 and method 450 both use the same steps 408, 410, 412, and 416. Method 450 uses steps 401, 403, and 405 instead of steps 404 and 406 of method 400. However, steps 401 and 406 are essentially the same steps, and steps 403, 404 and 405 are essentially the same steps. Steps 401, 403, and 405 differ from steps 404 and 406 in that the order in which the determination of whether the pre-existing contexts are adequate and are useful are reversed with respect to one another. In method 400, the determination of whether the pre-existing subclass is adequate is made first, while in method 450 the determination of whether the pre-existing subclass is useful is made first. However, whether or not the pre-existing context is useful, the pre-existing context may not be adequate. Consequently, in method 450, a determination of whether the pre-existing method is adequate is made in each branch of method 450 at steps 403 and 405. In contrast, if the pre-existing context is not useful, the pre-existing context is also not adequate. Consequently, one branch of method 400 does not need to determine whether the pre-existing method is adequate, and method 400 therefore includes one less step than method 450.

FIG. 4B indicates that if in step 403 a determination is made that the pre-existing context is adequate, to proceed to step 405, and from step 405 to proceed to return 416. However, in an alternative embodiment, method 450 proceeds directly from step 403 to return 416 without entering executing step 405. Specifically, since steps 403 and 405 make essentially the same determination, there may be no need to execute step 405 after executing step 403. In other embodiments, method 450 may include additional steps, may have one or more of the above steps in a different order, and/or may not include all of the steps listed above.

FIG. 5 shows a block diagram of an example of a method 500 for implementing step 306 of FIG. 3. In step 502 a starter is entered (which is a statement for which one or more variations are desired). In the example of an exam, the starter may be an exam question. In step 503, text accompanying the starter is varied in a manner consistent with the starter. In the example of an exam, the accompanying statements may be (1) wrong and right answers to the question, (2) an explanation of the answers, and/or (3) other hidden text.

In the example of an exam, step 503 may include the following sub-steps. In step 504, hidden text is entered. In step 506, correct answers are entered. The box representing step 506 is labeled “Enter correct answer(s)”, because there might be more than one correct answer. A multiple-choice question has exactly one correct answer, but a multiple true/false question may have more than one correct answer.

In step 508, one or more incorrect answers are entered. In optional step 510, an explanation is entered. After step 503, the method returns to the next step of the method of FIG. 3.

In other embodiments, method 500 may include additional steps, may have one or more of the above steps in a different order, and/or may not include all of the steps listed above. For example, steps 504, 506, 508, and 510 may be performed in any order with respect to one another.

FIG. 6 shows a block diagram of an example of a method 600 for implementing step 308 of FIG. 3. In step 602, ranges are configured. In step 604, formulae are configured. In step 606, leader-follower relationships are configured. In step 608, exclusion groups are configured. After step 608, the method returns to the next step of the method of FIG. 4.

In other embodiments, method 600 may include additional steps, may have one or more of the above steps in a different order, and/or may not include all of the steps listed above. The steps of method 600 may be performed in any order with respect to one another.

FIG. 7 shows a block diagram of an example of a method 700 for implementing step 310 of FIG. 3 for an embodiment in which the statement is an exam question. In other words, method 700 is only the part of step 310 that relates to a multiple choice exam question. In step 702, a decision is made as to whether the question is a multiple choice question or a multiple true/false question. Prior to step 702 there may be a step in which a decision is made as to the type of the statement. If the decision is that the statement is a multiple choice question, then the method proceeds to step 702. Step 702 may involve receiving input from a user indicating the type of question. Alternatively, in step 702, software 215 causes the automatic detection of whether the question is a multiple choice or multiple true/false question. If the question is a multiple true/false question, then method 700 proceeds to step 704. In step 704, the maximum and/or minimum number of answers is entered. Step 704 may involve presenting to a user a prompt to enter the maximum and/or minimum number of answers, and receiving information as a result of input from the user indicating the maximum and/or minimum number of answers. Next method 700 proceeds to step 706, where the maximum and/or minimum number of correct answers is entered. Similar to step 704, step 706 may involve presenting to a user a prompt to enter the maximum and/or minimum number of correct answers, and receiving information as a result of input from the user indicating the maximum and/or minimum number of correct answers. In another embodiment, step 706 may precede step 704 or be performed partially or completely simultaneously with step 704.

In an alternative embodiment, it may be possible to enter an exact number of desired total answers and/or correct answers in addition to or instead of entering a maximum and/or minimum number of total and/or of correct answers. Once the range of numbers of total answers is specified and a range of numbers of correct answers is specified, a range of numbers of incorrect answers can be determined. However, in an embodiment the user may specify a range of numbers of incorrect answers that can be specified. The number of incorrect answers may be specified in addition to or instead of specifying the number of total answers and/or the number of correct answers. In other words, an embodiment may include any one of, any combination of, or all of step 704, 706, and/or a step for selecting the number of acceptable wrong answers. Additionally, embodiments that allow the specification of the total number of answers, the number of correct answers, and/or the number of incorrect answers may or may not require that a specification be made.

Returning to step 702, if it is determined that the question is a multiple choice question, then in step 708 a maximum and/or minimum number of wrong answers may be specified. Specifying the maximum and/or minimum number of wrong answers may be required or optional. Additionally, in step 708, the user may be presented the option of specifying an exact number of wrong answers instead of, or in addition to, being able to specify the maximum and/or minimum number of wrong answers. In other embodiments, method 700 may include additional steps, may have one or more of the above steps in a different order, and/or may not include all of the steps listed above.

FIG. 8 shows a block diagram of an example of a method 800 for implementing step 312 of FIG. 3. In method 800 the appearance of the question and answer may be specified. In step 802, white spaces, such as tabs, indents for paragraphs, spaces between lines and letters, may be specified. In step 804, the appearance of the text, such as the font (e.g., the font width) may be specified. After step 804, control is returned to the next step of method 300. Steps 802 and 804 may be performed in any order with respect to one another. In other embodiments, method 800 may include additional steps and/or may not include all of the steps listed above.

FIG. 9 shows a block diagram of an example of a method 900 for implementing step 314 of FIG. 3. Method 900 is used to choose variants that are returned. In step 902 a determination is made as to how many variants exist for a given starter. Next in step 904, a decision is made whether the number of variants is too few. In an embodiment, the user may enter a number that represents the minimum number of desired variants. If there are too few variants, the method proceeds to step 906 in which the starter is modified to be less restrictive. Modifying the starter may include repeating at least part of any one of, any combination of, or all of steps 304, 306, and/or 310. In some cases it may also be desirable to repeat at least part of step 302, in order to make changes to the statement. Similarly, the changes made to the statement and/or starter may make repetition of step 310 desirable. After step 906, method 900 proceeds back to step 902 to determine the number of variants that will result from the less restrictive starter.

Returning to step 904, if the number of variants is not too few, method 900 proceeds to step 910. In step 910 a decision is made whether to output all of the variants or whether to output only a specified number of randomly chosen variants. For example, if the number of variants that could be produced is more than desired, it may be decided to generate only a specified number of randomly chosen variants. If a decision is made to generate only a specified number of randomly chosen variants, method 900 proceeds to step 912. In step 912, the specified number of variants is randomly chosen prior to actually generating the variants. By randomly choosing the variants prior to generating the variants (instead of after generating the variants), time and resources may be saved that would otherwise be used for generating variants that will not be used. In step 914, the variants are generated. If step 912 was performed, only the randomly selected variants are generated. If step 912 was not performed, all variants are generated. In an alternative embodiment, the variants are randomly selected after they are generated. In another embodiment, if a specified number or variants, represented by the letter X, are desired, then only the first, last, or another block of X variants are generated (instead of randomly selecting X variants to generate).

The steps of method 900 may be divided into four groups. The first group is step 902; the second group is steps 904 and 906, which relates to having too few variants; the third group is steps 910 and 912, which may relate to having too many variants; and the fourth group is step 912. The only group that is not optional is the fourth group. It may be desirable to perform the first group in order to aid in performing the second and/or the third group. In an embodiment, a decision whether to execute steps 906 and/or 910 may be made on a basis other than the number of variants produced.

In other embodiments, method 900 may include additional steps and/or may not include all of the steps listed above. The steps of method 900, may be performed in a different order than listed above.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A machine-implemented method comprising:
receiving at least a portion of a statement including a plurality of words; and
automatically forming one or more variations of at least the portion of the statement.

2. The method of claim 1, wherein the statement is a question suitable for an exam.

3. The method of claim 2, wherein the receiving and the automatically forming are applied to a group of questions.

4. The method of claim 3, wherein the group of questions form an exam, and the forming at least generates variations of an exam.

5. The method of claim 1, further comprising receiving text accompanying at least the portion of the statement.

6. The method of claim 5, wherein the forming further includes at least modifying the text in a manner that is consistent with the variations of at least the portion of the statement.

7. The method of claim 6, wherein the statement is a question; and
the text includes at least a portion of an answer to a question.

8. The method of claim 7, wherein the text also includes at least a portion of an explanation of the answer.

9. The method of claim 6, wherein the statement is a question, and the text includes at least a portion that contains subject matter that is of a nature that the subject matter would not be intended to be seen by an examinee.

10. The method of claim 1, wherein a structure associated with at least the portion of the statement is maintained in the one or more variations.

11. The method of claim 1, further comprising establishing at least one group of words that are substituted for one another when automatically forming the one or more variations.

12. The method of claim 11, further comprising:
establishing a hierarchical relationship between words within the group.

13. The method of claim 12, wherein when the forming replaces two or more words of the portion of the statement and when the two or more words have a hierarchical relationship to one another, then words that are used as substitutes for the two or more words, which were replaced, are chosen to have the hierarchical relationship.

14. The method of claim 1, further comprising:
establishing a plurality of groups of words in which the words of any particular group are substituted for other words of that particular when automatically forming the one or more variations; and
establishing one or more sets, each set including at least one or more groups selected from the plurality of groups, wherein for any particular set of the one or more sets, the at least one or more groups are related to one another by being associated with a common subject matter.

15. The method of claim 14, wherein the common subject matter of at least one of the one or more sets is a programming language.

16. The method of claim 1, further comprising:
establishing at least one group of words that are substituted for one another when automatically forming the one or more variations; and
restricting a substitution for a word to a set of words within the group.

17. The method of claim 1, further comprising establishing at least one formula that determines how to derive a word in a variant based on one or more other words in the variant.

18. The method of claim 17, wherein the word and the one or more other words are numbers, and the at least one formula is a mathematical relationship.

19. The method of claim 17, wherein the word and the one or more other words are logical variables, and the at least one formula is a logical expression.

20. The method of claim 1, further comprising establishing a relationship between two words, wherein if one of the two words is substituted for one word of at least the portion of the statement, the other word is substituted for another word of at least the portion of the statement.

21. The method of claim 1, further comprising establishing a group of words within at least the portion of the statement in which words within the group of words are precluded from being substituted with words that have identical values.

22. The method of claim 1, further comprising:
establishing at least one first group of words in which words of the first group are substituted for one another when automatically forming the one or more variations;
establishing at least one second group of words in which a word within the second group belongs to at least the portion of the statement, and the words of the second group are precluded from being substituted with words having identical values.

23. The method of claim 1, wherein:
(I) the receiving of at least the portion of the statement supports at least
(A) receiving accompanying text that accompanies at least the portion of the statement,
(B) the statement being a question,
(C) the accompanying text, if received, including at least
(a) an answer set having at least one or more answers to the question,
(b) an explanation of the answer set, and
(c) other text;
(II) the method further comprises receiving an indication of a type associated with the statement, wherein the receiving of the indication of the type supports at least
(A) a first type, which is a multiple choice question in which the answer set has only one correct answer and at least one wrong answer, and
(B) a second type, which is a multiple choice question in which the answer set includes at least more than one correct answer;
(III) the method supports at least receiving rules, wherein the receiving of the rules supports at least
(A) receiving an indication of a context, which is a designation of a subject matter associated with at least the portion of the statement,
(B) receiving at least one domain of words, which are a group of words that are indicated to be substitutable for one another,
(C) receiving at least one range of words within the group, wherein only words selected form the at least one range of words are substitutable for at least one particular word within the group, respectively,
(D) receiving at least one formula that determines a substitution for a given word based on substitutions chosen for one or more other words,
(E) receiving at least one set of at least two words, designated as having a leader-follower relationship, in which one of the at least two words is designated as a leader, and at least one other of the at least two words is designated as the follower, wherein the follower is substituted for a first word of at least the portion of the statement whenever the leader is substituted for a second word of at least the portion of the statement,
(F) receiving information designating at least one group of words as an exclusion group in which a value substituted for a word within the exclusion group must be different than all other values substituted for other words within the exclusion group,
(G) receiving information related to a desired appearance of at least the portion of the statement,
(H) receiving information related to a desired total number of answers in the answer set, if the answer set is received,
(I) if the statement is of the second type, receiving information related to a desired number of correct answers in the answer set;
(IV) the automatically forming includes at least substituting a first set of one or more words for a second set of one or more words within
(A) at least the portion of the statement, and
(B) the accompanying text, if received;
(V) wherein the substituting results in one or more variants of at least the portion of the statement, wherein the variants are based on at least
(A) the subject matter, if received,
(B) the at least one range, if received,
(C) the at least one formula, if received,
(D) the at least one leader-follower relationship, if received,
(E) the at least one group that is the exclusion group, if received,
(F) the appearance, if received; and
(VI) wherein if the one or more variants of do not conform to
(A) the information related to the desired total number of answers, if received, or
(B) the desired number of correct answers, if received and if the statement is of the second type,
then corrective action is taken with respect to the one or more variants that do not conform.

24. A system comprising a machine-readable medium carrying at least one or more groups of words, and
a designation for the one or more groups of words, wherein the designation indicates the words within a given group are be substitutable for one another.

25. The system of claim 23, wherein the machine-readable medium also carries at least a portion of a statement having at least one word belonging to the one or more groups of words.

26. The system of claim 23, wherein the machine-readable medium also carries at least one or more rules for substituting words within at least one group of the one or more groups.

27. The system of claim 23, wherein the machine-readable medium is a first machine-readable medium, which also carries at least a portion of a statement having at least one word belonging to the one or more word groups; and
the system further comprises
a second machine-readable medium located at a location remote from a location where the one or more groups were placed on the first machine-readable medium, and
the second machine-readable medium carrying one or more instructions for substituting one or more words within the one or more groups for one or more words within at least the portion of the statement.

28. A machine-readable medium carrying one or more instructions, which cause one or more processors to implement a method comprising:
receiving at least a portion of a statement including a plurality of words; and
automatically forming one or more variations of at least the portion of the statement.

29. A method comprising configuring a system to carry out one or more instructions, the instructions including at least:
receiving at least a portion of a statement including a plurality of words; and
automatically forming one or more variations of at least the portion of the statement.
